(19) United States
(12) Patent Application Publication
(10) Pub. No.: US 2011/0066481 A1
(43) Pub. Date: Mar. 17, 2011

(54) RANDOM PARTITIONING AND PARALLEL PROCESSING SYSTEM FOR VERY LARGE SCALE OPTIMIZATION AND METHOD

(76) Inventors: Alkiviadis Vazacopoulos, Harrington Park, NJ (US); Gabriel Tavares, Denville, NJ (US)

(21) Appl. No.: 12/558,310

(22) Filed: Sep. 11, 2009

(51) Int. Cl. G06Q 30/00; G06F 17/30

(52) U.S. Cl. 705/14.13; 707/E17.044

(57) ABSTRACT

A system for random partitioning and parallel processing of a very large data set includes a random partitioning component, and an optimization component which optimizes the mix of data in the random partitioning component, and an aggregation component which aggregates the optimization for each of the random partitions into a solution for the entire data set. The solution is substantially optimized for given rules and other constraints. The random partitioning produces a substantially optimized solution in a lesser time. The size of the random partitions can be selected so as to produce an optimal solution in a selected amount of time.

### BACKGROUND

This disclosure relates generally to a random partitioning and parallel processing system for very large scale optimization problems. The disclosure also discusses related methods used by the apparatus.

A common decision problem in marketing optimization is to determine what products to offer, what channels to use in the offering, and when the offer should be sent to a subset of customers.

This problem arises in many business contexts. In the retail industry the products to be offered could be the actual store products and the channel adopted could be a mailer to be sent to the customer households say every month (e.g. across a total of 6 months period). The products and customer selections could be defined so that the propensity of the selected customers to buy the selected products would be as large as possible, or so that the overall profit would increase with the adopted marketing choices. In the financial context this type of problem arises for example in collections and credit offerings. For the later case the product offering could be certain types of credit cards and the credit limits. The channels to be used could be regular mail, phone call or email. The goal in this case would be to increase profit while controlling both risk and cost.

In terms of optimization terminology the previous decision problem is an assignment problem with global constraints. The assignment is done across a set of customers and a set of offers (sometimes called treatments). Each offer may consist of a product, a channel and a time period. The global constraints define limits in terms of the resources availability, such as a maximum number of customers getting an offer, number of times that a given channel could be used, and a total marketing budget.

In today's marketplace, it is common to find problems of this nature involving tens of millions of customers and hundreds of offers. Such problems are referred to as very large scale optimization (“VLSO”) problems and occur in a number of settings. A large retail store has millions of customers and has in inventory thousands of products. Banks could offer 50 different products across a subset of 10 channels to a subset of tens of millions of customers. These massive decision problems clearly require a Very Large Scale Optimization (VLSO) system and technology to be able to find solutions involving tens of billions of assignment decisions across a few hundred/thousands of global constraints. Theoretically the assignment problem just described is in the category of NP-hard optimization problems. Current systems for optimizing such a VLSO would require a large amount of computing time and would require massive amounts of memory.

### BRIEF DESCRIPTION OF THE INVENTION

The above-mentioned shortcomings, disadvantages and problems are addressed herein. A system for random partitioning and parallel processing of a very large data set includes a random partitioning component, and an optimization component which optimizes the mix of data in the random partitioning component, and an aggregation component which aggregates the optimization for each of the random partitions into a solution for the entire data set. The solution is substantially optimized for given rules and other constraints. The random partitioning produces a substantially optimized solution in a lesser time. The size of the random partitions can be selected so as to produce an optimal solution in a selected amount of time. A computer-implemented method includes receiving the customer data along with the global constraints and treatments. The customer data is partitioned. The global constraints are decomposed so that the resulting constraints are sized to the size of the random partitions. Optimization then takes place on all the partitions which are subsets of the customer data. The optimization takes place in a distributed computing environment over a plurality of processors. Once the optimization on the subsets is complete, the optimizations are aggregated to produce a substantially optimal solution for the customer data set. Implementation of this method on machine readable media is also discussed.

### BRIEF DESCRIPTION OF THE DRAWINGS

These and other aspects will now be described in detail with reference to the following drawings.

FIG. 1 is a schematic diagram of a partitioning and parallel processing system, according to an example embodiment.

FIG. 2 is a schematic diagram of another embodiment of a partitioning and parallel processing system, according to an example embodiment.

FIG. 3 is a flowchart of a computer-implemented method for determining an optimal mix of products and offers, according to an example embodiment.

FIG. 4 is a flowchart of another computer-implemented method for determining an optimal mix of products and offers, according to an example embodiment.

FIG. 5 is a block diagram of a media and an instruction set, according to an example embodiment.

FIG. 6 is a graph showing the decrease in time to determine a substantially optimal solution for various numbers of treatments, according to an example embodiment.

FIG. 7 is a graph showing the decrease in memory needed to determine a substantially optimal solution for various numbers of treatments, according to an example embodiment.

Like reference symbols in the various drawings indicate like elements.

### DETAILED DESCRIPTION

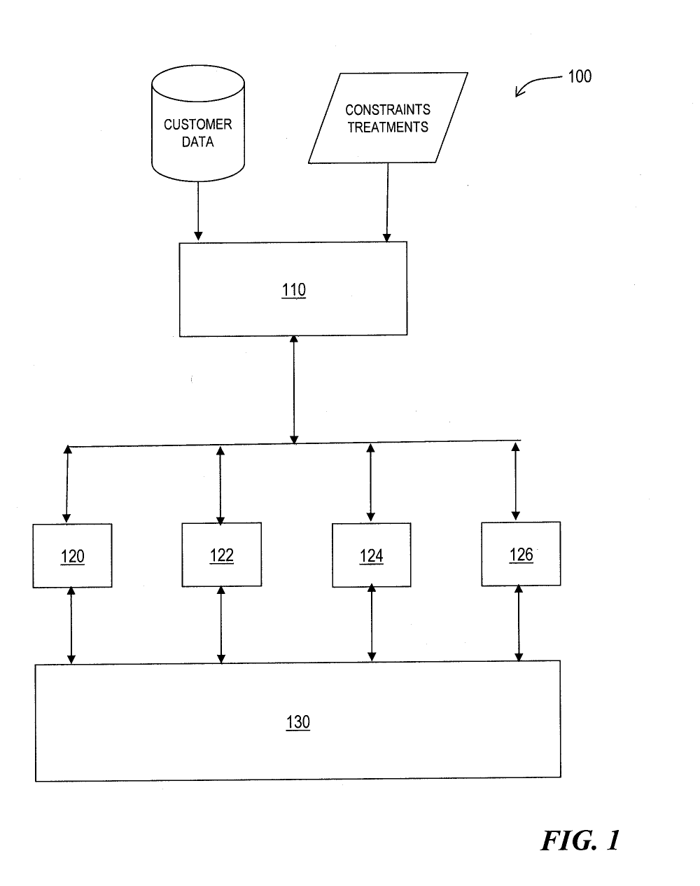

FIG. 1 is a schematic diagram showing an overview of a random partitioning and parallel processing system 100, according to an example embodiment. The random partitioning and parallel processing system 100 includes a partitioning component 110 for forming a plurality of customer data subsets from a customer data set, a plurality of processors 120, 122, 124, 126 for applying a set of constraints and a set of treatments to the plurality of subsets of customer data to determine an optimal solution for the subsets of customer data, and an aggregation component 130 for aggregating a plurality of optimal solutions to a plurality of customer data subsets to generate a substantially optimal solution for the customer data set. In one embodiment, the partitioning component 110 generates random partitions within the customer data to form the plurality of customer data subsets. The subsets are randomized with respect to the mix of customers in each subset. The subsets can be randomized in other manners as well. The subsets, in this embodiment, do not include all the customers in the customer data set that have selected common characteristics, for example. Suitable sizes for the partitions can be selected so that near-optimal or marginally optimal solutions can be obtained in less time than previous solutions.

In one embodiment, there is at least one processor for each of the plurality of subsets of customer data. In another embodiment, it is envisioned that there may be some processors which are not separate. In other words, there may be at least one processor that is a portion of another processor. So, it could be that a single processor includes multiple dedicated portions and so each of two customer data subsets are serviced by separate portions of one processor. The separate portions of the processor may act like separate processors. In many instances, the plurality of processors 120, 122, 124, 126 are associated with a distributed computer architecture environment. In some embodiments, the processors may be servers owned by others, such as servers operating in a cloud environment. Global constraints applicable to the customer data set are generally decomposed to a suitable constraint for each of the customer data subsets. The size of the partition, in some embodiments, can be selected to allow for computing a solution for the customer data set within a selected time. Of course, it should be noted that there could be only one constraint or many constraints for a given VLSO. For example, multiple constraints can be part of a single VLSO solution. Constraints can relate to many aspects of the solution, including limit total number of credit offers over a selected amount, a limit for the total campaign cost, and the like.

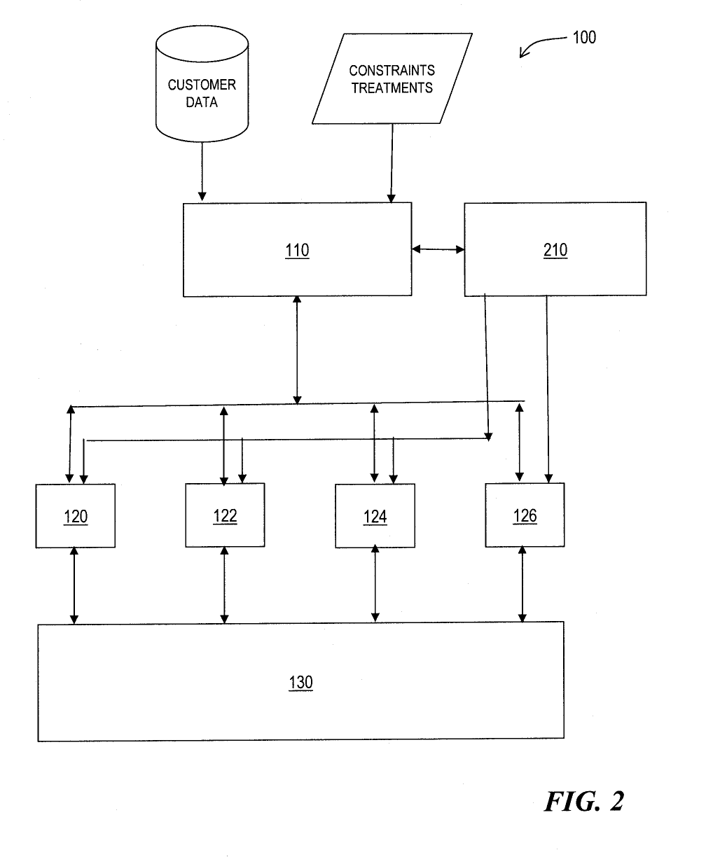

FIG. 2 is a schematic diagram of another embodiment of a partitioning and parallel processing system 200, according to an example embodiment. For the sake of brevity, the differences between the first embodiment and the second embodiment will be discussed rather than discussing the entire embodiment. The partitioning system 200 includes a decomposing component 210 for decomposing a global constraint into a plurality of sub constraints 220, 222, 224 and 226 for each of the partitions. The sub constraints are sized so they are appropriate for the partitions of the customer data. In some instances, the sub constraints 220, 222, 224 and 226 may be the same. In other instances, the sub constraints may be different, or at least one may be different. It should be noted that only four processors are shown in FIGS. 1 and 2 and that the number of processors can be any number of processors. The computing time for determining a global constraint is reduced as the number of processors is increased. If a VLSO has a plurality of constraints, it should also be noted that the partitioning system 200 also may handle a plurality of constraints associated with a VLSO.

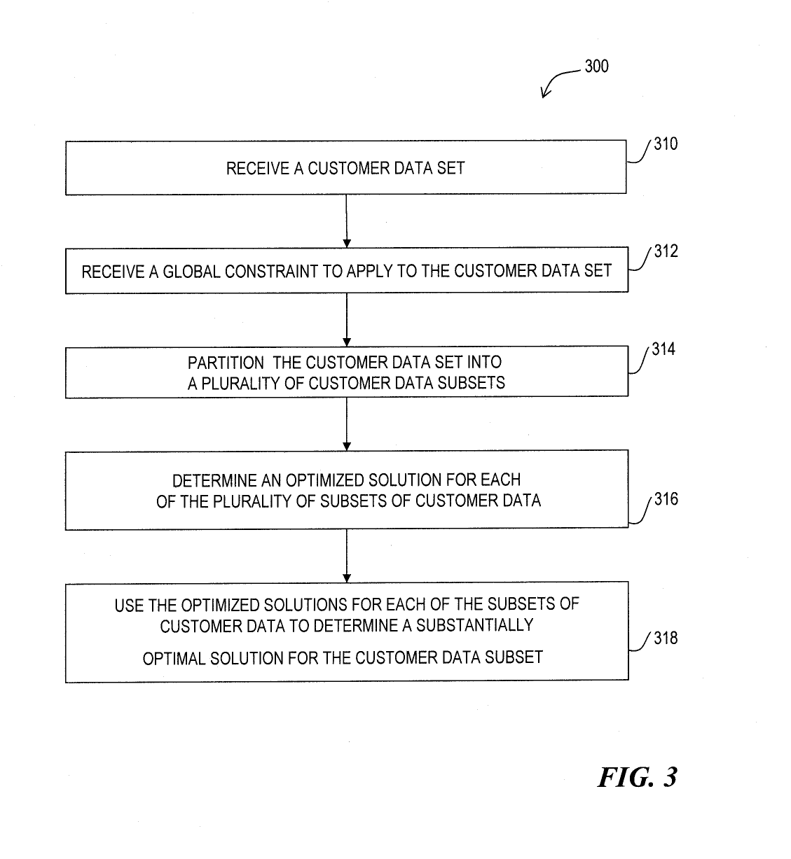

FIG. 3 is a flowchart of a computer-implemented method 300 for determining an optimal mix of products and offers, according to an example embodiment. The computer-implemented method 300 for determining an optimal mix of products and offers includes receiving a customer data set 310, receiving a global constraint to apply to the customer data set 312, and partitioning the customer data set into a plurality of customer data subsets 314. An optimized solution for each of the plurality of subsets of customer data is then determined 316, and then the optimized solutions for each of the subsets of customer data are used to determine a substantially optimal solution for the customer data subset 318. The substantially optimal solution is applied to the customer data set to make offers to customers 320. These offers can be for any type of product, such as consumable products in the store or for sale on the internet, or for financial products, such as mortgages, investment instruments and the like. In one embodiment, the partitioning of customer data 314 generates random subsets of customer data. To determine the optimized solution 318 for each of the plurality of subsets of customer data, the operations may be performed over a plurality of processors. In some embodiments, plurality of processors are associated with a distributed computer architecture environment. In some example embodiments, receiving a global constraint to apply to the customer data set 312 includes receiving a plurality of global constraints or constraints to apply to the customer data set.

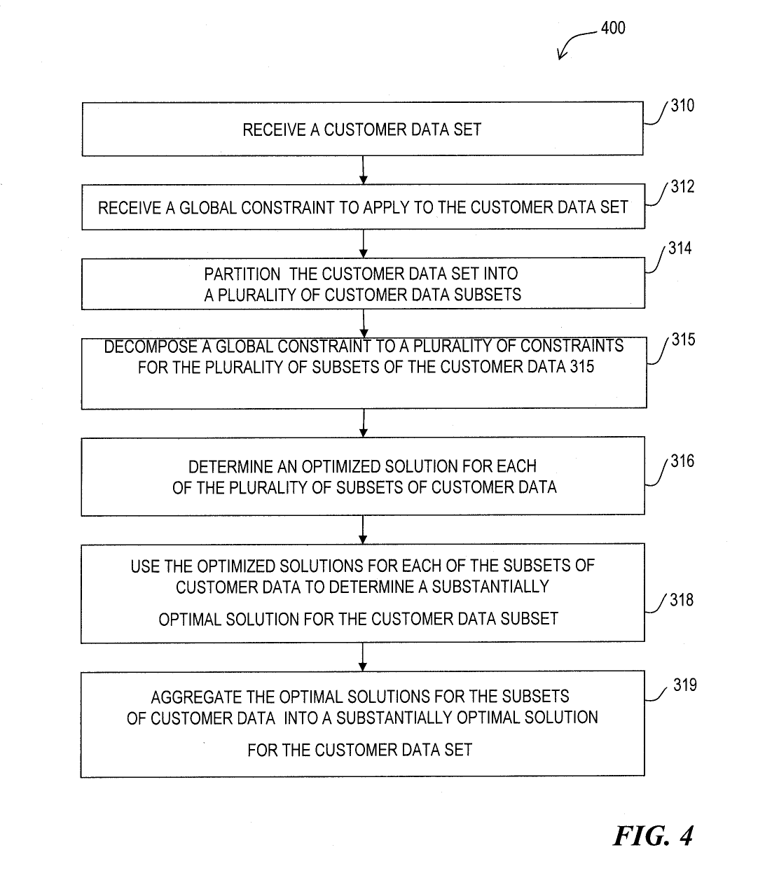

FIG. 4 is another embodiment of a computer-implemented method 400. The computer-implemented method 400 includes many of the same steps as the computer-implemented method 300. The additional steps will be detailed with respect to the method 400 rather than describing the entire embodiment in detail. The computer-implemented method 400 includes decomposing a global constraint to a plurality of constraints for the plurality of subsets of the customer data 315. In addition, using the optimized solutions for each of the subsets of customer data to determine a substantially optimal solution for the customer data subset include aggregating the optimal solutions for the subsets of customer data into a substantially optimal solution for the customer data set.319. It should also be noted that in some embodiments, receiving a global constraint to apply to the customer data set can include receiving a plurality of global constraints or constraints to apply to the customer data set.

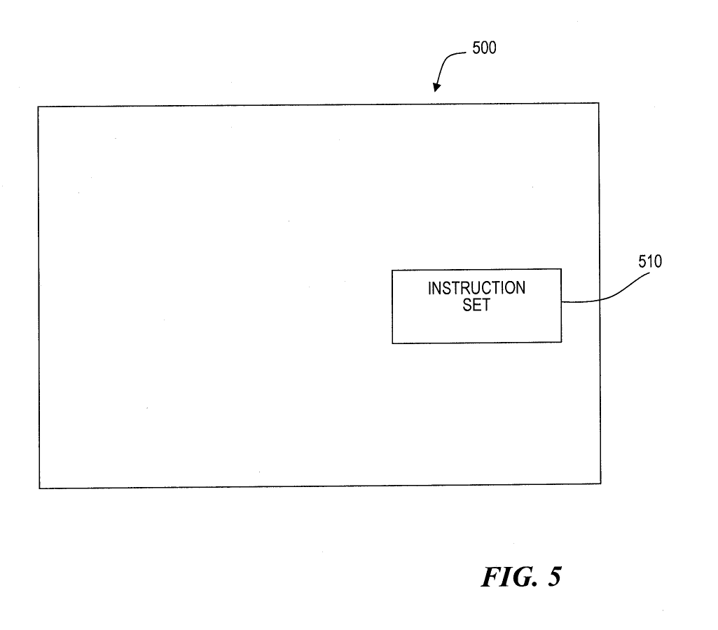

FIG. 5. is a schematic diagram of a machine readable medium 500, according to an embodiment of the invention. The machine readable medium 500 includes a set of instructions 510 which are executable by a machine such as a computer system. When executed, the machine follows the instruction set 510. The machine readable media can be any type of media including memory, floppy disk drives, hard disk drives, a connection to the internet or even a server which stores the machine at a remote location. The machine readable medium 500, according to one embodiment, provides instructions 510 that, when executed by a machine, cause the machine to receive a customer data set, receive a global constraint to apply to the customer data set, partition the customer data set into a plurality of customer data subsets, determine an optimized solution for each of the plurality of subsets of customer data, and use the optimized solutions for each of the subsets of customer data to determine a substantially optimal solution for the customer data subset. The substantially optimal solution is then applied to the customer data set to make offers to customers. In one embodiment, the machine readable medium 500 includes instructions that further cause the machine to partition the customer data into random subsets of customer data. The machine readable medium 500 may also include instructions for determining the optimized solution for each of the plurality of subsets of the customer over a plurality of processors. The machine readable medium 500 also may carry instructions 510 that further cause the machine to decompose the global constraint into a plurality of constraints for the plurality of subsets of the customer data. In some embodiments, the instructions 510 may further cause the machine to select the size of the partitions of the global customer data in response to an amount of time desired to obtain a substantially optimum solution. The machine readable medium may also include instructions 510 that further cause the machine to aggregate the optimized solutions for the partitions to yield a substantially optimized solution for the customer data set.

Various implementations of the subject matter of the method and apparatus described above may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the method and apparatus described above may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The methods and apparatus described and contemplated above may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter of Appendix A), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

### Example Embodiment

One embodiment of a framework to handle VLSO problems is proposed here. The apparatus and method of this example embodiment provides a “near”-optimal solution to a VLSO by applying a state-of-the-art Mixed Integer Programming (MIP) software package, such as FICO Xpress available from Fair Isaac Corporation, 901 Marquette Avenue, Minneapolis, Minn. FICO Xpress may be termed as optimization software. The solution is provided through a distributed computer architecture environment.

The framework proposed here is based on a Randomized Partition (RP) of the customers set C into a disjoint partition of k customer subsets: C=C₁∪C₂∪Cₖ. The original VLSO is decomposed into the solution of k smaller optimization problems. Every global constraint of VLSO is satisfied by decomposing it into a suitable constraint of each partition.

The practical evidence gathered from solving VLSO problems by RP is that the marginal gain of the objective function is exponentially decreasing with the increase of the size of the segments. In one study case involving 40 million customers and about 700 offers, the marginal gain of using a partition of 25,000 customers instead of a partition of 150,000 customers is only 0.01%.

TABLE 1
Total time needed to solve the 40 million customers study case.

Number of Customers on Each
Partition

| Computers | CPUs | 25000 | 50000 | 75000 | 100000 |
|---|---|---|---|---|---|
| 1 | 1 | 43.1 h | 53.0 h | 62.9 h | 72.9 h |
| 10 | 4 | 1.4 h | 1.8 h | 2.1 h | 2.4 h |

According to the study case, it would take 612 days to solve the VLSO problem to optimality, i.e. assuming that it was solved by a “standard” (single CPU) computer system with access to “massive” amounts of memory. Error! Reference source not found.Table 1 shows that a solution marginally close to the optimal solution of VLSO could be found in 1.8 hours using “standard” computer technology by applying RP over partitions (segments) of 50000 customers each. Table 2 also shows that the 50000 customers optimization sub-problem would fit in 8.1 GB of memory which meets the capacity requirements available for today's computers.

TABLE 2
Total memory needed to solve the 40 million customers study case.
Number of Customers on Each Partition

| 25000 | 50000 | 75000 | 100000 |
|---|---|---|---|
| 4.0 GB | 8.1 GB | 12.1 GB | 16.2 GB |

The various embodiments of the partitioning and parallel processing system 100, 200 described above as well as the embodiments of the methods 300, 400 used by a computing system decrease the time necessary to compute a VLSO problem. An example VLSO includes 37 million customers with at least one global constraint. If there are 20 potential product offerings or treatments that can be applied to each of the 37 million customers, an estimate of the solve time needed to optimize the offerings is approximately 612 days. This assumes that a computer with a single central processing unit and an unlimited amounts of memory are available for determining the optimal mix of product offerings or treatments to the 37 million customers.

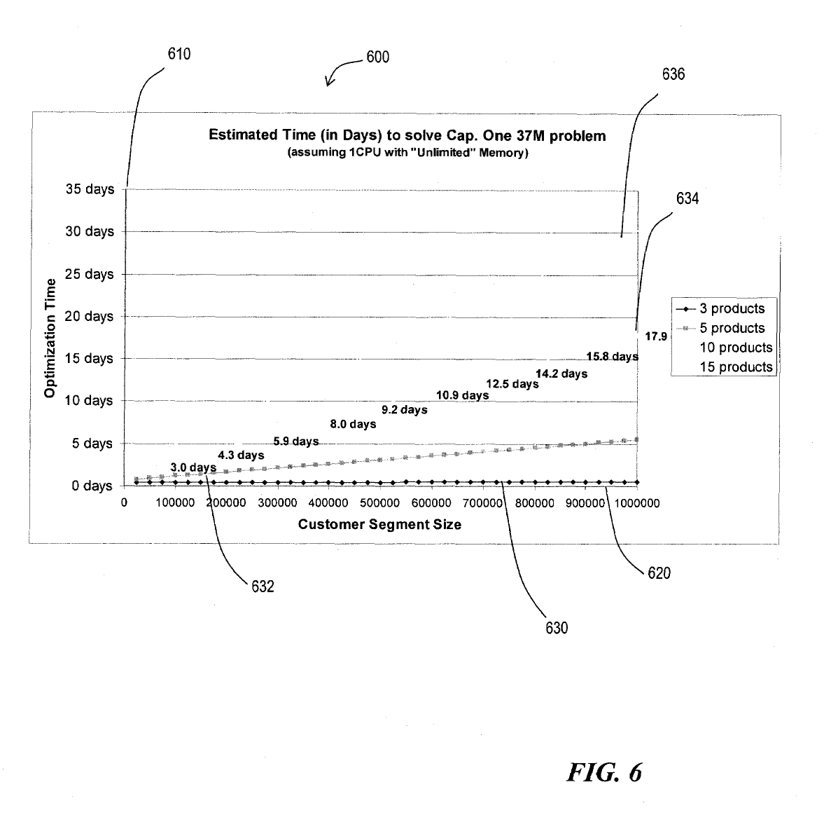

FIG. 6 is a graph 600 showing the decrease in time to determine a substantially optimal solution for various numbers of treatments. In short, the computing time is reduced significantly when compared to the 612 days previously mentioned. The graph 600 includes a y-axis 610 depicting the optimization time or the amount of time needed to complete the operations to arrive at a substantially optimal solution. The graph 600 also includes a y-axis 620 depicting the size of the partition or the number of customers in a subset of the customer data. The compute times to reach a substantially optimal solution are set forth on the graph 600. The compute or optimization time for 3 treatments or products is set forth as a plot 630, the optimization time for 5 treatments or products is set forth as a plot 632, the optimization time for 10 treatments or products is set forth as a plot 634, and the optimization time for 15 treatments or products is set forth as a plot 636. For example, looking at plot 634, the optimization time when the number of customers in a randomized subset is 100,000 is 3 days. Another example, looking at plot 636, the optimization time when the number of customers in a randomized subset is 100,000 is just over 5 days. Of course, this is down significantly from the 612 day time discussed previously.

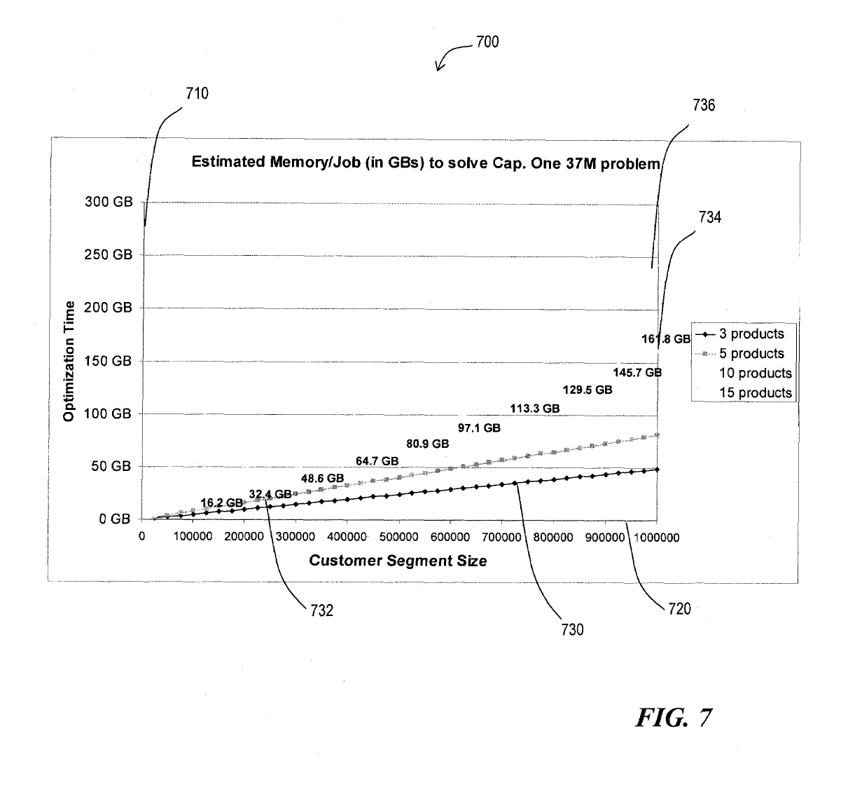

FIG. 7 is a graph 700 showing the decrease in memory needed to determine a substantially optimal solution for various numbers of treatments. In short, the amount of memory needed is reduced significantly when compared to the unlimited amount needed as previously mentioned. The graph 700 includes a y-axis 710 depicting the amount of memory needed to complete the operations to arrive at a substantially optimal solution. The graph 700 also includes a y-axis 720 depicting the size of the partition or the number of customers in a subset of the customer data. The memory amounts needed to reach a substantially optimal solution are set forth on the graph 600. The amount of memory needed to compute an optimization for 3 treatments or products is set forth as a plot 730, the amount of memory needed to compute an optimization for 5 treatments or products is set forth as a plot 732, the amount of memory needed to compute an optimization for 10 treatments or products is set forth as a plot 734, and the amount of memory needed to compute an optimization for 15 treatments or products is set forth as a plot 736. For example, looking at plot 734, the amount of memory needed when the number of customers in a randomized subset is 100,000 is 16.2 gigabytes (GB). Another example, looking at plot 636, the amount of memory needed when the number of customers in a randomized subset is 100,000 is about 25 GB. Of course, this is down significantly from the unlimited amount needed as discussed previously in the example. Also important is that the amount of memory is an amount which can be easily made available in current computing environments.

Although a few variations have been described and illustrated in detail above, it should be understood that other modifications are possible. In addition it should be understood that the logic flow depicted in the accompanying figures and described herein do not require the particular order shown, or sequential order, to achieve desirable results. Other embodiments may be within the scope of the following claims.

What we claim is:

1. A partitioning and parallel processing system comprising:
a partitioning component for forming a plurality of customer data subsets from a customer data set;
a plurality of processors for applying a set of contraints and a set of treatments to the plurality of subsets of customer data to determine an optimal solution for the subsets of customer data; and
a aggregation component for aggregating a plurality of optimal solutions to a plurality of customer data subsets to generate a substantially optimal solution for the customer data set.

2. The system of claim 1 wherein the partitioning component generates random partitions within the customer data to form the plurality of customer data subsets.

3. The system of claim 2, wherein there is at least one processor for each of the plurality of subsets of customer data.

4. The system of claim 2, wherein there is at least one processor for each of the plurality of subsets of customer data, the processor can be a portion of another processor.

5. The system of claim 1, wherein the plurality of processors are associated with a distributed computer architecture environment.

6. The system of claim 1, wherein there is a constraint to be applied to the customer data set that is decomposed to a suitable constraint for each of he customer data subsets.

7. The system of claim 1, wherein the size of the partition is selected to allow for computing a solution within a selected time.

8. A computer-implemented method for determining an optimal mix of products and offers comprising:
receiving a customer data set;
receiving a global constraint to apply to the customer data set;
partitioning the customer data set into a plurality of customer data subsets;
determining an optimized solution for each of the plurality of subsets of customer data; and
using the optimized solutions for each of the subsets of customer data to determine a substantially optimal solution for the customer data subset; and
applying the substantially optimal solution to the customer data set to make offers to customers.

9. The computer-implemented method of claim 8, wherein the partitioning of customer data generates random subsets of customer data.

10. The computer-implemented method of claim 8, wherein determining the optimized solution for each of the plurality of subsets of customer data is performed over a plurality of processors.

11. The computer-implemented method of claim 8, wherein determining the optimized solution for each of the plurality of subsets of customer data is performed over a plurality of processors associated with a distributed computer architecture environment.

12. The computer-implemented method of claim 1, further comprising decomposing a global constraint to a plurality of constraint for the plurality of subsets of the customer data.

13. The computer-implemented method claim 8, wherein using the optimized solutions for each of the subsets of customer data to determine a substantially optimal solution for the customer data subset includes aggregating the optimal solutions for the subsets of customer data into a substantially optimal solution for the customer data set.

14. A machine readable tangibly embodied storage medium that provides instructions that, when executed by a machine, cause the machine to:
receive a customer data set;
receive a global constraint to apply to the customer data set;
partition the customer data set into a plurality of customer data subsets;
determine an optimized solution for each of the plurality of subsets of customer data; and
use the optimized solutions for each of the subsets of customer data to determine a substantially optimal solution for the customer data subset; and
applying the substantially optimal solution to the customer data set to make offers to customers.

15. The machine readable medium of claim 14 that provides instructions that further cause the machine to partition the customer data into random subsets of customer data.

16. The machine readable medium of claim 14, wherein the instructions for determining the optimized solution for each of the plurality of subsets of customer data further include instructions to perform the determining step over a plurality of processors.

17. The machine readable medium of claim 14 that provides instructions that further cause the machine to decompose the global constraint into a plurality of constraints for the plurality of subsets of the customer data.

18. The machine readable medium of claim 14 that provides instructions that further cause the machine to select the size of the partitions of the global customer data in response to an amount of time desired to obtain a substantially optimum solution.

19. The machine readable medium of claim 14 that provides instructions that further cause the machine to use the optimized solutions for each of the subsets of customer data to determine a substantially optimal solution for the customer data subset further includes instructions to aggregate the optimized solutions for the partitions to yield a substantially optimized solution for the customer data set.
